(19) United States
(12) Patent Application Publication
(10) Pub. No.: US 2022/0208004 A1
(43) Pub. Date: Jun. 30, 2022

(54) DRIVING SUPPORT APPARATUS, DRIVING SUPPORT METHOD, AND COMPUTER-READABLE RECORDING MEDIUM

(71) Applicant: NEC Corporation, Minato-ku, Tokyo (JP)

(72) Inventor: Jun ONO, Tokyo (JP)

(73) Assignee: NEC Corporation, Minato-ku, Tokyo (JP)

(21) Appl. No.: 17/259,747

(22) PCT Filed: Jul. 3, 2019
(86) PCT No.: PCT/JP2019/026467

§ 371 Date: Apr. 8, 2021

(30) Foreign Application Priority Data
Jul. 13, 2018 (JP) 2018-133139

(51) Int. Cl. G08G 1/16; G06V 20/54; H04N 7/18; G09G 3/00; G06V 10/764; G02B 27/01

(52) U.S. Cl. CPC G08G 1/16; G06V 20/54; H04N 7/18; B60Q 9/008; G06V 10/764; G02B 27/0101; G09G 2380/10; G09G 3/002

(57) ABSTRACT

The driving support device (10) acquires information on an object existing in the blind spot of a vehicle and provides the information to the driving entity. The driving support apparatus is apparatus to assist the driving of a vehicle, includes: an information acquisition unit (20) configured to acquire a first sensor data output from a first sensor mounted on the vehicle and a second sensor data output from a second sensor installed outside the vehicle; an analysis unit (30) configured to specify the type of an object existing around the vehicle based on the first sensor data and the second sensor data; a presentation unit (40) configured to present the identified type of the object to the driving entity.

### TECHNICAL FIELD

The present invention relates to a driving support apparatus and a driving support method that support the driving of a vehicle, and further to a computer-readable recording medium where a program for realizing these is recorded.

### BACKGROUND ART

In recent years, the IoT (Internet of Things) market has grown rapidly, and according to one theory, it is predicted that more than 30 billion IoT devices will be connected to the network by 2020. Automobiles are also considered as one of these IoT devices, and efforts are being made toward autonomous driving using IoT.

By the way, in an automobile, in order to prevent an accident from occurring, whether it is when driving automatically or when driving by a person, it is important to accurately acquire bling spots information and provide it to the control device or the driver. For this reason, various techniques have been conventionally proposed to acquire the bling spots information and provide them (see, for example, Patent Documents 1 to 3).

For example, Patent Document 1 discloses a device that detects a vehicle other than its own vehicle. Specifically, the device disclosed in Patent Document 1 detects another vehicle approaching the own vehicle by analyzing the sound collected by the sound collecting microphone attached to the front of the vehicle. If possible, the device disclosed in Patent Document 1 turn on the lamp in the driver's instrument panel in the vehicle.

Patent Document 2 also discloses a device for detecting a vehicle other than the own vehicle. However, unlike the device disclosed in Patent Document 1, the device disclosed in Patent Document 2 detects dangerous object existing in the vicinity of the own vehicle based on sensor signals from sensors such as a radar and an infrared camera mounted on the own vehicle. Further, on detecting a dangerous object, the device disclosed in Patent Document 2 projects the detection result onto the windshield by the head-up display.

Further, Patent Document 3 discloses a device for monitoring the periphery of the own vehicle. The device disclosed in Patent Document 3 acquires an image of a place that is a blind spot for the driver by a camera installed in the own vehicle and displays the acquired image on the windshield. In addition, the device disclosed in Patent Document 3 can also call attention to the driver when it detects a moving object in an image.

As described above, by using the devices disclosed in Patent Documents 1 to 3, it is possible to provide the information on the blind spot to the control device or the driver who drives the automobile.

### LIST OF RELATED ART DOCUMENTS

### Patent Document

Patent Document 1: Japanese Unexamined Utility Model (Registration) Application Publication No. H06-11099

Patent Document 1: Japanese Patent Laid-Open Publication No. 2017-45128

Patent Document 1: Japanese Patent Laid-Open Publication No. 2001-18717

### SUMMARY OF INVENTION

### Problems to be Solved by the Invention

However, each of the devices disclosed in Patent Documents 1 to 3 has a problem that the information on the blind spot is insufficiently provided.

Specifically, the device disclosed in Patent Document 1 detects a vehicle only by the sound collected by the sound collecting microphone. Therefore, the device disclosed in Patent Document 1 may not be able to determine whether the vehicle is approaching the vehicle or moving away from the vehicle.

Further, the devices disclosed in Patent Documents 2 and 3 have a problem that the detection range is narrow because the radar or the camera mounted on the own vehicle detects other vehicles and the like. That is, the devices disclosed in Patent Documents 2 and 3 have a problem that they cannot detect a person, a vehicle, or the like existing in the shadow. In addition, the device disclosed in Patent Document 3 has a problem that it is difficult to detect when the visibility is poor such as at night because the detection is performed only by the camera.

An example object of the present invention is to provide a driving support apparatus, a driving support method, and a computer-readable recording medium that can solve the aforementioned problems and acquire information on an object in a blind spot of a vehicle and provide the information to the driving entity.

### Means for Solving the Problems

To achieve the aforementioned example object, a driving support apparatus according to an example aspect of the present invention is an apparatus for assisting the driving of a vehicle, includes:

an information acquisition unit that acquires the first sensor data output from the first sensor mounted on the vehicle and the second sensor data output from the second sensor installed outside the vehicle;

an analysis unit that specifies the type of an object existing around the vehicle based on the first sensor data and the second sensor data;

a presentation unit that presents the identified type of the object to the driving entity.

Furthermore, to achieve the aforementioned example object, a driving support method according to an example aspect of the present invention is a method for assisting the driving of a vehicle, includes:

(a) a step of acquiring the first sensor data output from the first sensor mounted on the vehicle and the second sensor data output from the second sensor installed outside the vehicle;

(b) a step of specifying the type of an object existing around the vehicle based on the first sensor data and the second sensor data;

(c) a step of presenting the identified type of the object to the driving entity.

Moreover, to achieve the aforementioned example object, a computer-readable recording medium according to an example aspect of the present invention has recorded therein a program for assisting the driving of a vehicle by a computer, including an instruction that causes a computer to execute:

(a) a step of acquiring the first sensor data output from the first sensor mounted on the vehicle and the second sensor data output from the second sensor installed outside the vehicle;

(b) a step of specifying the type of an object existing around the vehicle based on the first sensor data and the second sensor data;

(c) a step of presenting the identified type of the object to the driving entity.

### Advantageous Effects of the Invention

As described above, according to the present invention, it is possible to acquire information on an object existing in a blind spot of a vehicle and provide the information to the driving entity.

### BRIEF DESCRIPTION OF THE DRAWINGS

FIG. 1 is a block diagram showing a schematic configuration of a driving support apparatus according to an example embodiment of the present invention.

FIG. 2 is a block diagram more specifically showing the configuration of the driving support apparatus according to the example embodiment of the present invention.

FIG. 3 is an explanatory diagram illustrating the function of the driving support apparatus according to the present example embodiment.

FIG. 4 is an explanatory diagram illustrating the function of the driving support apparatus according to the present example embodiment.

FIG. 5 is a diagram showing an example of an icon presented by the driving support apparatus according to the present example embodiment.

FIG. 6 is a flow diagram showing the operations of the driving support apparatus according to the example embodiment of the present invention.

FIG. 7 is a block diagram showing an example of a computer that realizes a driving support apparatus according to the example embodiment of the present invention.

### EXAMPLE EMBODIMENT

(Example Embodiment)

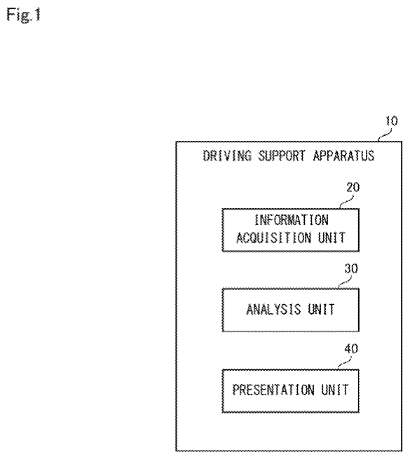

The following describes a driving support apparatus, a driving support method, and a program according to an example embodiment of the present invention with reference to FIG. 1 to FIG. 7.

[Apparatus Configuration]

First, a schematic configuration of the driving support apparatus according to the present example embodiment will be described using FIG. 1. FIG. 1 is a block diagram showing a schematic configuration of a driving support apparatus according to an example embodiment of the present invention.

A driving support apparatus 10 according to the present example embodiment shown in FIG. 1 is an apparatus for assisting the driving of a vehicle. As shown in FIG. 1, the driving support apparatus 10 includes an information acquisition unit 20, an analysis unit 30 and a presentation unit 40.

The information acquisition unit 20 acquires a first sensor data (hereinafter referred to as “in-vehicle sensor data”) output from a first sensor (hereinafter referred to as “in-vehicle sensor”) mounted on the vehicle and the second sensor data (hereinafter referred to as “out-of-vehicle sensor data”) output from the second sensor (hereinafter referred to as “out-of-vehicle sensor”) installed outside the vehicle

The analysis unit 30 specifies the type of an object existing around the vehicle to be the target of driving support (hereinafter referred to as “own vehicle”) based on the in-vehicle sensor data and the out-of-vehicle sensor data acquired by the information acquisition unit 20. The presentation unit 40 presents the type of the object identified by the analysis unit 30 to the driving entity of the own vehicle.

As described above, in the present example embodiment, the type of the object around the own vehicle is identified by using not only the in-vehicle sensor data output by the in-vehicle sensor but also the out-of-vehicle sensor data output by the out-of-vehicle sensor. That is, in the present example embodiment, the information of the object existing in the blind spot of the vehicle can be acquired by the out-of-vehicle sensor installed on the road and the in-vehicle sensor, and this information can be presented to the driving entity. As a result, according to the present example embodiment, the safety of the vehicle is significantly improved. In the present example embodiment, the driving entity includes not only a person who is a driver but also a control device that performs automatic driving.

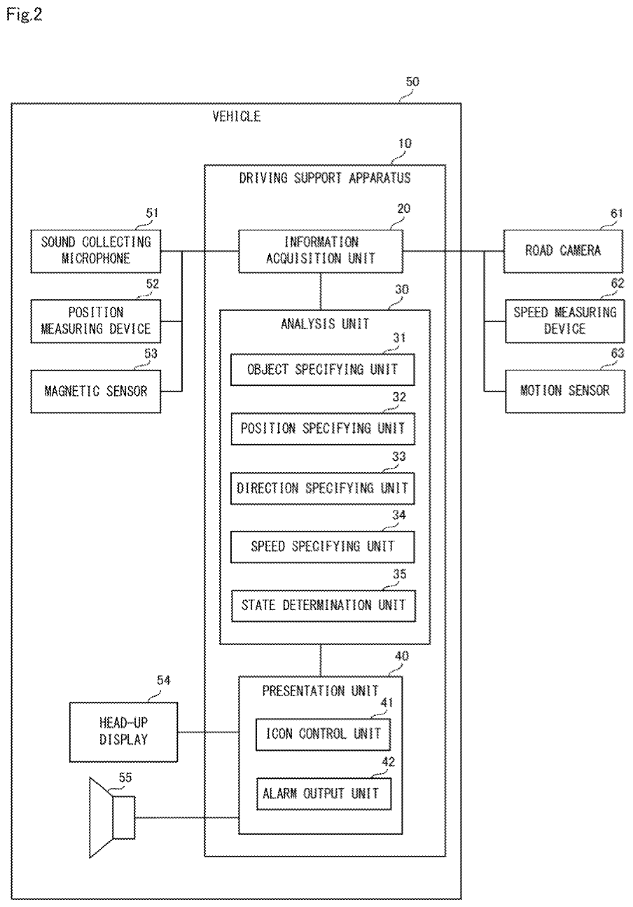

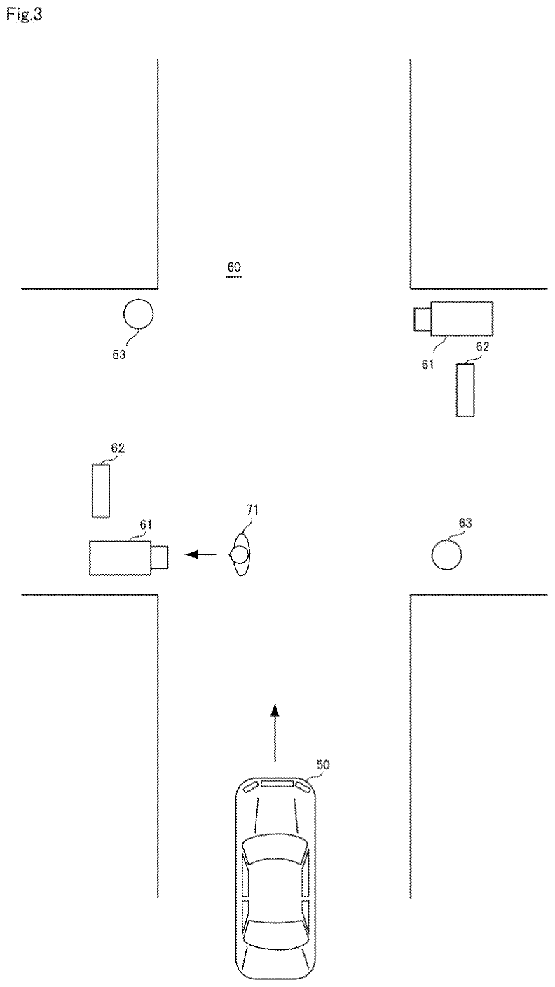

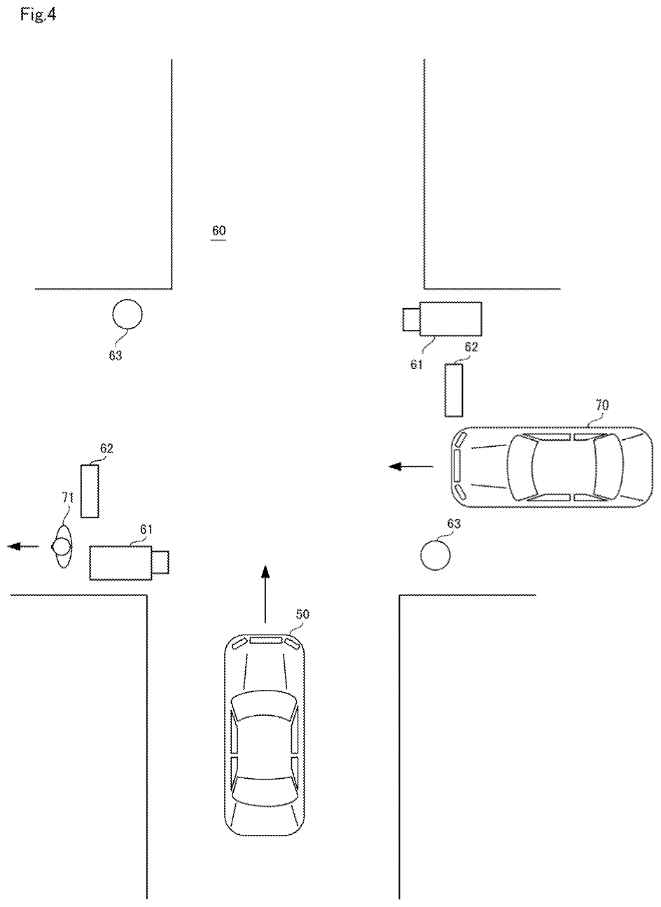

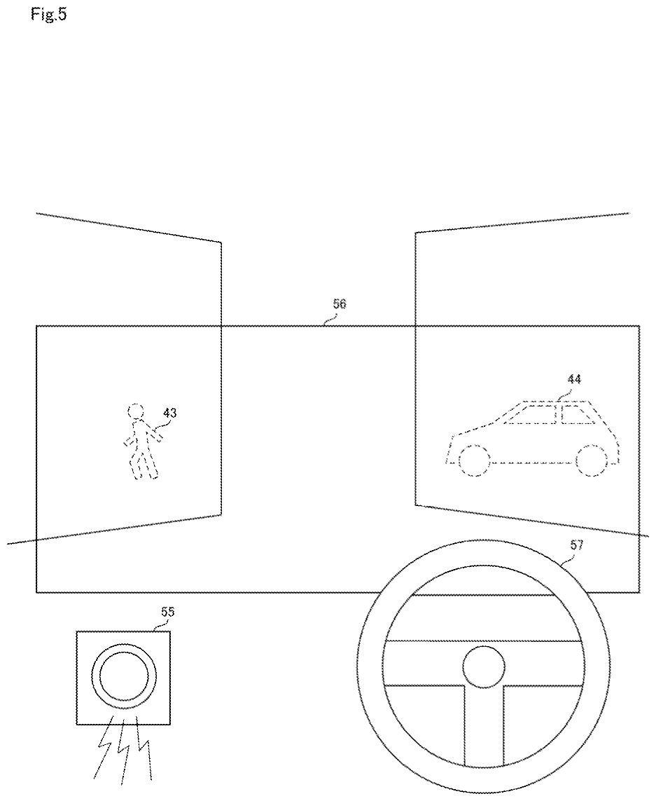

Next, the specifics of the configuration and functions of the driving support apparatus according to the present example embodiment will be described using FIG. 2 to FIG. 5. FIG. 2 is a block diagram more specifically showing the configuration of the driving support apparatus according to the example embodiment of the present invention. FIGS. 3 and 4 are an explanatory diagram illustrating the function of the driving support apparatus according to the present example embodiment. FIG. 5 is a diagram showing an example of an icon presented by the driving support apparatus according to the present example embodiment.

As shown in FIG. 2, in the present example embodiment, the driving support apparatus 10 is mounted on the vehicle (own vehicle) 50. The vehicle 50 includes a sound collecting microphone 51, a position measuring device 52, and a magnetic sensor 53 as in-vehicle sensors.

Of these, the sound collecting microphone 51 outputs sound data that specifies the sound generated around the own vehicle. The position measuring device 52 is, for example, GPS (Global Position System) receiver, and outputs position data for specifying the position coordinates of the own vehicle 50. The magnetic sensor 53 detects the geomagnetism and outputs direction data for specifying the traveling direction of the own vehicle 50.

Further, the vehicle 50 also includes a head-up display 54. The head-up display 54 has a function of projecting various information onto the windshield of the vehicle 50.

Further, in the present example embodiment, a road camera 61, a speed measuring device 62, and a motion sensor 63 are installed as out-of-vehicle sensors on the outside of the vehicle 50, for example, on the road or in a building.

Of these, the street camera 61 outputs video data of the captured area. The speed measuring device 62 measures the speed of an object moving on the road by millimeter waves or the like, and outputs speed data for specifying the measured speed. The motion sensor 63 detects a person existing in the vicinity thereof and outputs detection data indicating the presence or absence of the person.

Further, as shown in FIGS. 3 and 4, the road camera 61, the speed measuring device 62, and the motion sensor 63 are installed at points where accidents are likely to occur, such as a crossroads 60 with a poor view. Further, these out-of-vehicle sensors and the vehicle 50 are wirelessly connected to each other so that data communication is possible.

Further, the in-vehicle sensor and the out-of-vehicle sensor shown in FIGS. 2 to 4 are examples. In the present example embodiment, sensors other than the above-mentioned sensors may be used as the in-vehicle sensor and the out-of-vehicle sensor. Other examples of the in-vehicle sensor include a radar and a camera. Further, examples of the out-of-vehicle sensor include a sound collecting microphone, an illuminance sensor, a raindrop sensor, and the like.

In the present example embodiment, the information acquisition unit 20 acquires sound data from the sound collecting microphone 51, position data from the position measuring device 52, and direction data from the magnetic sensor 53 as in-vehicle sensor data. Further, the information acquisition unit 20 acquires video data from the road camera 61, speed data from the speed measuring device 62, and detection data from the motion sensor 63 as out-of-vehicle sensor data. The information acquisition unit 20 outputs these acquired data to the analysis unit 30.

As shown in FIG. 2, in the present example embodiment, the analysis unit 30 includes an object specifying unit 31, a position specifying unit 32, a direction specifying unit 33, a speed specifying unit 34, and a state determination unit 35.

The object specifying unit 31 specifies the type of an object existing near the own vehicle 50 based on the sound data from the sound collecting microphone 51, the video data from the road camera 61, and the detection data from the motion sensor 63.

Specifically, the object specifying unit 31 first compares the feature amount of the image in the frame with the preset feature amount of the person and the feature amount of the vehicle for each frame of the video data, specifies an object existing around the own vehicle 50, and specifies the type of the identified object. Further, when the type of the object is not specified from the video data due to bad weather, nighttime, etc., the object specifying unit 31 specifies the type of the object by the sound data and the detection data.

The position specifying unit 32 specifies the position coordinates (latitude, longitude) of the own vehicle 50 based on the position data from the position measuring device 52. In addition, the position specifying unit 32 also specifies the position coordinates (latitude, longitude) of the specified object from the position of the vehicle in the video data and the position coordinates (latitude, longitude) of the road camera 61.

The direction specifying unit 33 specifies the traveling direction of the own vehicle 50 based on the direction data from the magnetic sensor 53. In addition, the direction specifying unit 33 also specifies the traveling direction of the specified object from the video data. Further, in case that the object is a vehicle, the direction specifying unit 33 can specify the traveling direction of the object from the change in the sound level specified by the sound data. Further, the speed specifying unit 34 specifies the moving speed of the specified object based on the speed data from the speed measuring device 62.

In case that the vehicle is specified as the type of the object, the state determination unit 35 determines whether or not the object is approaching the own vehicle 50. Specifically, the state determination unit 35 determines whether or not the object is approaching the own vehicle 50 based on the position coordinates and the traveling direction of the own vehicle 50 and the position coordinates and the traveling direction of the specified object. Further, in this case, the state determination unit 35 also calculates the distance between the own vehicle 50 and the object, and the angle formed by the traveling direction of the own vehicle and the traveling direction of the object.

Subsequently, the operation of the analysis unit 30 will be described with reference to FIGS. 3 and 4. As shown in FIG. 3, it is assumed that the own vehicle 50 is approaching the crossroads 60 with poor visibility. The road camera 61, the speed measuring device 62, and the motion sensor 63 described above are installed at the crossroads 60. In addition, a pedestrian 71 is about to cross in front of the own vehicle 50.

Then, as shown in FIG. 4, another vehicle 70 is approaching the crossroads 60 in addition to the pedestrian 71 at a position invisible from the own vehicle 50. In this case, the road camera 61 outputs video data showing the vehicle 70 and the pedestrian 71. Further, the motion sensor 63 outputs the detection data that detects the pedestrian 71. Further, the speed measuring device 62 outputs speed data for specifying the speed of the vehicle 70.

Further, in the own vehicle 50, the sound collecting microphone 51 outputs sound data in which the sound of the vehicle 70 is recorded. The position measuring device 52 outputs the position data for specifying the position coordinates of the own vehicle 50. The magnetic sensor 53 outputs the direction data for specifying the traveling direction of the own vehicle 50.

Therefore, in the analysis unit 30, the object specifying unit 31 specifies the vehicle 70 and the pedestrian 71 at the crossroads 60 from the video data unless the weather is bad or at night. Further, the position specifying unit 32 specifies the position coordinates of the own vehicle 50, the vehicle 70, and the pedestrian 71. The direction specifying unit 33 specifies the traveling directions of the own vehicle 50, the vehicle 70, and the pedestrian. Further, the speed specifying unit 34 specifies the speed of the vehicle 70. Then, the state determination unit 35 determines that the vehicle 70 is approaching. And the state determination unit 35 calculates the distance between the own vehicle 50 and the vehicle 70, and the angle formed by the traveling direction of the own vehicle 50 and the traveling direction of the vehicle 70.

Further, as shown in FIG. 2, the presentation unit 40 includes an icon control unit 41 and an alarm output unit 42 in the present embodiment. The icon control unit 41 presents an icon indicating an object whose type has been specified by the analysis unit 30 to the driving entity (driver) of the own vehicle 50.

In the present example embodiment, the icon control unit 41 presents an icon corresponding to the type of the object on the windshield 56 by the head-up display 54. Further, the icon control unit 41 can present the icon to the driving entity at the timing when the icon indicating the object is projected onto the windshield 56 by the head-up display 54 so that the icon overlaps the scenery seen from the own vehicle 50. That is, in the present example embodiment, the icon can be displayed in AR (Augmented Reality). In this case, the time required for the driver, who is the driving entity, to detect the danger can be greatly shortened, so that the occurrence of an accident is greatly suppressed.

Specifically, for example, in the examples of FIGS. 3 and 4 described above, the vehicle 70 is on the right side and the pedestrian 71 is on the left side based on the own vehicle 50. Therefore, as shown in FIG. 5, the head-up display 54 projects the icon 43 representing the pedestrian 71 on the left side and the icon 44 representing the vehicle 70 on the right side on the windshield 56. In FIG. 5, “57” indicates a handle.

Further, in case that the type of the object is a vehicle, the icon control unit 41 can reflect the determination result of the state determination unit 35 on the icon. For example, the icon control unit 41 can increase the size of the icon 44 indicating the vehicle as the distance between the vehicle and the own vehicle 50 becomes smaller. Further, in case that the state determination unit 35 calculates the angle between the traveling direction of the own vehicle 50 and the traveling direction of the object, the icon control unit 41 can also adjust the orientation, shape, position, and the like of the icon so that the driving entity can grasp the angle.

Further, in case that the image taken by the camera mounted in front of the vehicle is displayed on the screen of the display device of the driver's seat, the icon control unit 41 superimposes an icon indicating an object on the image. In this case as well, the icon will be displayed in AR.

For example, when the distance between the own vehicle 50 and the object becomes equal to or less than the threshold value, the alarm output unit 42 outputs an alarm to the driving entity. Specifically, as shown in FIG. 2, the alarm output unit 42 outputs a warning sound by the speaker 55 mounted on the own vehicle 50. Further, the alarm output unit 42 can enlarge the icon of the object, change the color of the icon, and display another icon indicating the alarm, as an alarm.

[Apparatus Operations]

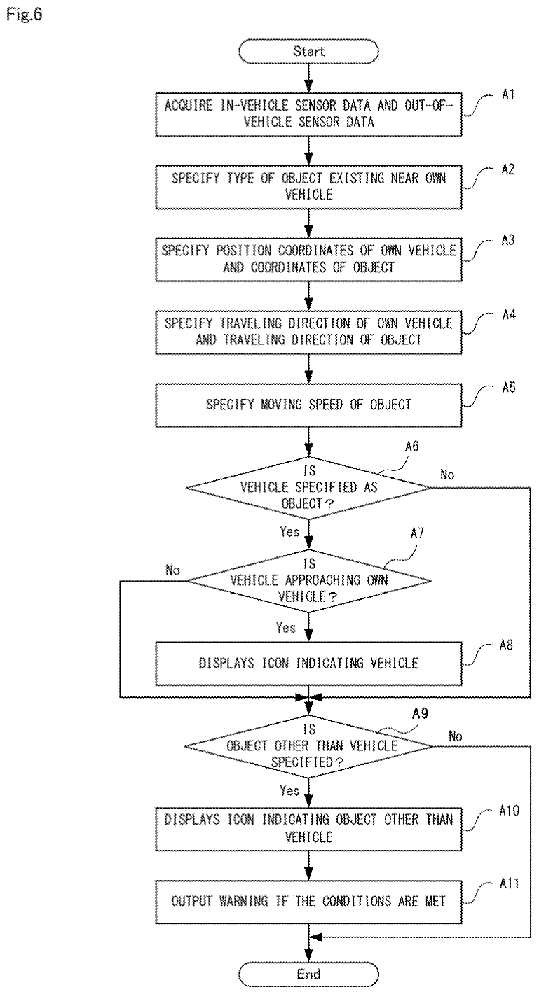

Next, the operations of the driving support apparatus 10 according to the present example embodiment will be described using FIG. 6. FIG. 6 is a flow diagram showing the operations of the driving support apparatus according to the example embodiment of the present invention. In the following description, FIG. 1 to FIG. 5 will be referred to as appropriate. Furthermore, in the present example embodiment, the driving support method is carried out by causing the driving support apparatus 10 to operate. Therefore, the following description of the operations of the driving support apparatus 10 applies to the driving support method according to the present example embodiment.

As shown in FIG. 6, first, the information acquisition unit 20 acquires the in-vehicle sensor data from the in-vehicle sensor and acquires the out-of-vehicle sensor data from the out-of-vehicle sensor (step A1).

Next, in the analysis unit 30, the object specifying unit 31 specifies the type of the object existing near the own vehicle 50 based on the sound data from the sound collecting microphone 51, the video data from the road camera61, and the detection data from the motion sensor 63.

Next, the position specifying unit 32 specifies the position coordinates (latitude, longitude) of the own vehicle 50 based on the position data from the position measuring device 52, and also specifies the position coordinates (latitude, longitude) of the object whose type is specified based on the position of the vehicle in the video data and the position coordinates (latitude, longitude) of the road camera 61. (step A3).

Next, the direction specifying unit 33 specifies the traveling direction of the own vehicle 50 based on the direction data from the magnetic sensor 53, and also specifies the traveling direction of the object whose type is specified from the video data (step A4).

Next, the speed specifying unit 34 specifies the moving speed of the object whose type is specified in step A2 based on the speed data from the speed measuring device 62 (step A5).

Next, the state determination unit 35 determines in step A2 whether or not the vehicle is specified as an object (step A6). If the vehicle 70 is not specified as a result of the determination in step A6, step A9 described later is executed.

If the vehicle 70 is specified as a result of the determination in step A6, the state determination unit 35 determines whether or not the vehicle 70 is approaching the own vehicle 50 based on the processing results of steps A3 and A4 (step A7). As a result of the determination in step A7, if the vehicle 70 is not approaching, step A9 described later is executed.

As a result of the determination in step A7, if the vehicle 70 is approaching, the state determination unit 35 notifies the presentation unit 40 of that fact. As a result, in the presentation unit 40, the icon control unit 41 displays the icon 44 indicating the vehicle 70 on the windshield 56 by the head-up display 54 (step A8).

Further, in step A8, the icon control unit 41 increases the size of the icon 44 indicating the vehicle as the distance between the vehicle 70 and the own vehicle 50 decreases. And the icon control unit 41 adjusts the direction, shape, position, etc. of the icon so that the driver can grasp the angle formed by the traveling direction of the own vehicle 50 and the traveling direction of the vehicle 70.

Next, the state determination unit 35 determines in step A2 whether or not an object other than the vehicle, for example, a pedestrian 71 is specified (step A9). If an object other than the vehicle is not specified as a result of the determination in step A9, the process in the driving support apparatus 10 ends.

On the other hand, if an object other than the vehicle is specified as a result of the determination in step A9, the state determination unit 35 notifies the presentation unit 40 of that fact. As a result, in the presentation unit 40, the icon control unit 41 displays, for example, an icon 43 indicating a pedestrian 71 on the windshield 56 by the head-up display 54 (step A10).

Next, in the presentation unit 40, the alarm output unit 42 outputs an alarm to the driver when, for example, the condition that the distance between the own vehicle 50 and the object becomes equal to or less than the threshold value is satisfied (step A11).

If the determination in step A9 is No, or if step A11 is executed, the processing in the driving support device 10 ends once. But, as long as the own vehicle 50 is in operation, the process from step A1 is executed again after a set interval.

[Effect in Example Embodiment]

As described above, according to the present example embodiment, the information on the object existing in the blind spot of own vehicle can be acquired by the out-of-vehicle sensor installed on the road and the in-vehicle sensor, and this information can be presented to the driving entity. Therefore, the safety of the vehicle is greatly improved.

Further, in the present embodiment, the icon of the object existing in the blind spot can be AR-displayed. Furthermore, in the present example embodiment, the object existing in the blind spot can be specified even in bad weather or at night. Therefore, according to the present example embodiment, the safety is further enhanced.

[Program]

It is sufficient for the program according to the present example embodiment to be a program that causes a computer to execute steps A1 to A11 shown in FIG. 6. The driving support apparatus 10 and the driving support method according to the present example embodiment can be realized by installing this program in the computer and executing this program. In this case, a processor of the computer functions as the information acquisition unit 20, analysis unit 30 and presentation unit 40, and performs processing. The computer used in the present example embodiment is not particularly limited, but if the driving support device 10 is mounted on the vehicle, the computer may be an in-vehicle computer.

Furthermore, the program according to the present example embodiment may be executed by a computer system constructed with a plurality of computers. In this case, for example, each computer may function as one of the information acquisition unit 20, analysis unit 30 and presentation unit 40.

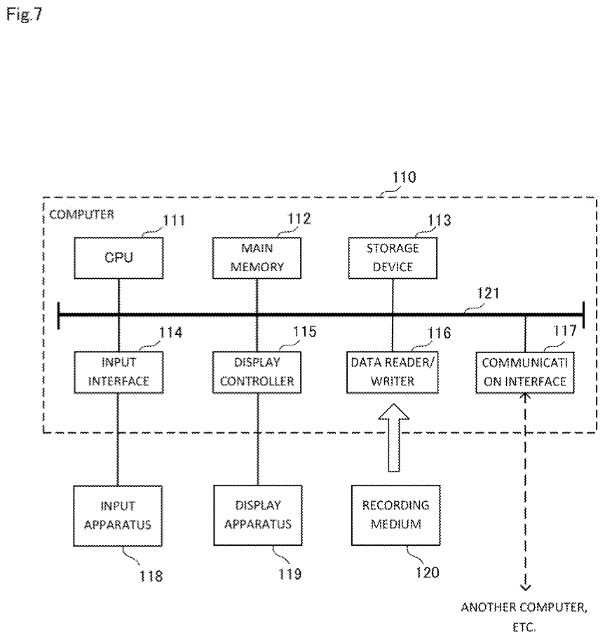

Using FIG. 7, the following describes a computer that realizes the driving support apparatus 10 by executing the program according to the present example embodiment. FIG. 7 is a block diagram showing an example of a computer that realizes the driving support apparatus according to the example embodiment of the present invention.

As shown in FIG. 7, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121. Note that the computer 110 may include a GPU (Graphics Processing Unit) or an FPGA (Field-Programmable Gate Array) in addition to the CPU 111, or in place of the CPU 111.

The CPU 111 carries out various types of calculation by deploying the program (codes) according to the present example embodiment stored in the storage device 113 to the main memory 112 and executing the codes in a predetermined order. The main memory 112 is typically a volatile storage device, such as a DRAM (dynamic random-access memory). Also, the program according to the present example embodiment is provided in a state where it is stored in a computer-readable recording medium 120. Note that the program according to the present example embodiment may be distributed over the internet connected via the communication interface 117.

Also, specific examples of the storage device 113 include a hard disk drive and a semiconductor storage device, such as a flash memory. The input interface 114 mediates data transmission between the CPU 111 and an input apparatus 118, such as a keyboard and a mouse. The display controller 115 is connected to a display apparatus 119, and controls display on the display apparatus 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that the driving support apparatus 10 according to the present example embodiment can also be realized by using items of hardware that respectively correspond to the components, rather than the computer in which the program is installed. Furthermore, a part of the driving support apparatus 10 may be realized by the program, and the remaining part of the driving support apparatus 10 may be realized by hardware.

A part or an entirety of the above-described example embodiment can be represented by (Supplementary Note 1) to (Supplementary Note 15) described below, but is not limited to the description below.

(Supplementary Note 1)

A driving support apparatus to assist the driving of a vehicle, including:

an information acquisition unit configured to acquire a first sensor data output from a first sensor mounted on the vehicle and a second sensor data output from a second sensor installed outside the vehicle;

an analysis unit configured to specify the type of an object existing around the vehicle based on the first sensor data and the second sensor data;

a presentation unit configured to present the identified type of the object to the driving entity.

(Supplementary Note 2)

The driving support apparatus according to supplementary note 1, wherein

the presentation unit presents an icon indicating the object of which the type has been identified to the driving entity of the vehicle.

(Supplementary Note 3)

The driving support apparatus according to supplementary note 2, wherein

in the case where the identified type of the object is a vehicle, the analysis unit determines whether or not the object is approaching the vehicle,

the presentation unit reflects the result of the determination on the icon.

(Supplementary Note 4)

The driving support apparatus according to supplementary note 2 or 3, wherein

the presentation unit presents the icon to the driving entity so as to overlap scenery seen from the vehicle.

(Supplementary Note 5)

The driving support apparatus according to any one of supplementary notes 1 to 4, wherein

the first sensor includes a sound collecting microphone, a position measuring device, and a magnetic sensor,

the second sensor is installed on the road or in a building and includes a speed measuring device, a motion sensor, and a camera.

(Supplementary Note 6)

A driving support method to assist the driving of a vehicle, including:

(a) a step of acquiring the first sensor data output from the first sensor mounted on the vehicle and the second sensor data output from the second sensor installed outside the vehicle;

(b) a step of specifying the type of an object existing around the vehicle based on the first sensor data and the second sensor data;

(c) a step of presenting the identified type of the object to the driving entity.

(Supplementary Note 7)

The driving support method according to supplementary note 6, wherein

in the (c) step, an icon indicating the object of which the type has been identified is presented to the driving entity of the vehicle.

(Supplementary Note 8)

The driving support method according to supplementary note 7, wherein

in the (b) step, in the case where the identified type of the object is a vehicle, it is determined whether or not the object is approaching the vehicle,

in the (c) step, the result of the determination is reflected in the icon.

(Supplementary Note 9)

The driving support method according to supplementary note 7 or 8, wherein

in the (c) step, the icon is presented to the driving entity so as to overlap scenery seen from the vehicle.

(Supplementary Note 10)

The driving support method according to any one of supplementary notes 6 to 9, wherein

the first sensor includes a sound collecting microphone, a position measuring device, and a magnetic sensor,

the second sensor is installed on the road or in a building and includes a speed measuring device, a motion sensor, and a camera.

(Supplementary Note 11)

A computer-readable recording medium in which a program is recorded, the program for assisting the driving of a vehicle by a computer, including an instruction that causes the computer to carry out:

(a) a step of acquiring the first sensor data output from the first sensor mounted on the vehicle and the second sensor data output from the second sensor installed outside the vehicle;

(b) a step of specifying the type of an object existing around the vehicle based on the first sensor data and the second sensor data;

(c) a step of presenting the identified type of the object to the driving entity.

(Supplementary Note 12)

The computer-readable recording medium to supplementary note 11, wherein

in the (c) step, an icon indicating the object of which the type has been identified is presented to the driving entity of the vehicle.

(Supplementary Note 13)

The computer-readable recording medium according to supplementary note 12, wherein

in the (b) step, in the case where the identified type of the object is a vehicle, it is determined whether or not the object is approaching the vehicle,

in the (c) step, the result of the determination is reflected in the icon.

(Supplementary Note 14)

The computer-readable recording medium according to supplementary note 12 or 13, wherein

in the (c) step, the icon is presented to the driving entity so as to overlap scenery seen from the vehicle.

(Supplementary Note 15)

The computer-readable recording medium according to any one of supplementary notes 11 to 14, wherein

the first sensor includes a sound collecting microphone, a position measuring device, and a magnetic sensor,

the second sensor is installed on the road or in a building and includes a speed measuring device, a motion sensor, and a camera.

As described above, according to the present invention, the analysis on a control program can be assisted in a case where the safety of a plant is assessed. The present invention is useful for various types of plants that are controlled by a control device.

This application is based upon and claims the benefit of priority from Japanese application No. 2018-133139, filed on Jul. 13, 2018, the disclosure of which is incorporated herein in its entirety by reference.

### INDUSTRIAL APPLICABILITY

As described above, according to the present invention, it is possible to acquire information on an object existing in a blind spot of a vehicle and provide the information to the driving entity. The present invention is useful for various vehicles that require driving.

### DESCRIPTION OF REFERENCE SIGNS

10 Driving support apparatus
20 Information acquisition unit
30 Analysis unit
31 Object specifying unit
32 Position specifying unit
33 Direction specifying unit
34 Speed specifying unit
35 State determination unit
40 Presentation unit
41 Icon control unit
42 Alarm output unit
43, 44 Icon
50 Vehicle (own vehicle)
51 Sound collecting microphone
52 Position measuring device
53 Magnetic sensor
54 Head-up display
55 Speaker
56 Windshield
57 Handle
60 Crossroads
61 Road camera
62 Speed measuring device
63 Motion sensor
70 Other vehicle
71 Pedestrian
110 Computer
111 CPU
112 Main memory
113 Storage device
114 Input interface
115 Display controller
116 Data reader/writer
117 Communications interface
118 Input device
119 Display device
120 Recording medium
121 Bus

What is claimed is:

1. A driving support apparatus to assist the driving of a vehicle, comprising:
an information acquisition configured to acquire a first sensor data output from a first sensor mounted on the vehicle and a second sensor data output from a second sensor installed outside the vehicle;
an analysis configured to specify the type of an object existing around the vehicle based on the first sensor data and the second sensor data;
a presentation configured to present the identified type of the object to the driving entity.

2. The driving support apparatus according to claim 1, wherein
the presentation unit presents an icon indicating the object of which the type has been identified to the driving entity of the vehicle.

3. The driving support apparatus according to claim 2, wherein
in the case where the identified type of the object is a vehicle, the analysis unit determines whether or not the object is approaching the vehicle,
the presentation unit reflects the result of the determination on the icon.

4. The driving support apparatus according to claim 2, wherein
the presentation unit presents the icon to the driving entity so as to overlap scenery seen from the vehicle.

5. The driving support apparatus according to claim 1, wherein
the first sensor includes a sound collecting microphone, a position measuring device, and a magnetic sensor,
the second sensor is installed on the road or in a building and includes a speed measuring device, a motion sensor, and a camera.

6. A driving support method to assist the driving of a vehicle, comprising:
acquiring the first sensor data output from the first sensor mounted on the vehicle and the second sensor data output from the second sensor installed outside the vehicle;
specifying the type of an object existing around the vehicle based on the first sensor data and the second sensor data;
presenting the identified type of the object to the driving entity.

7. A non-transitory computer-readable recording medium in which a program is recorded, the program for assisting the driving of a vehicle by a computer, including an instruction that causes the computer to carry out:
acquiring the first sensor data output from the first sensor mounted on the vehicle and the second sensor data output from the second sensor installed outside the vehicle;
specifying the type of an object existing around the vehicle based on the first sensor data and the second sensor data;
presenting the identified type of the object to the driving entity.

8. The driving support method according to claim 6, wherein
in the presenting, an icon indicating the object of which the type has been identified is presented to the driving entity of the vehicle.

9. The driving support method according to claim 8, wherein
in the specifying, in the case where the identified type of the object is a vehicle, it is determined whether or not the object is approaching the vehicle,
in the presenting, the result of the determination is reflected in the icon.

10. The driving support method according to claim8, wherein
in the presenting, the icon is presented to the driving entity so as to overlap scenery seen from the vehicle.

11. The driving support method according to claim 6, wherein
the first sensor includes a sound collecting microphone, a position measuring device, and a magnetic sensor,
the second sensor is installed on the road or in a building and includes a speed measuring device, a motion sensor, and a camera.

12. The non-transitory computer-readable recording medium to claim 7, wherein
in the presenting, an icon indicating the object of which the type has been identified is presented to the driving entity of the vehicle.

13. The non-transitory computer-readable recording medium according to claim 12, wherein
in the specifying, in the case where the identified type of the object is a vehicle, it is determined whether or not the object is approaching the vehicle,
in the presenting, the result of the determination is reflected in the icon.

14. The non-transitory computer-readable recording medium according to claim 12, wherein
in the presenting, the icon is presented to the driving entity so as to overlap scenery seen from the vehicle.

15. The non-transitory computer-readable recording medium according to claim 7, wherein
the first sensor includes a sound collecting microphone, a position measuring device, and a magnetic sensor,
the second sensor is installed on the road or in a building and includes a speed measuring device, a motion sensor, and a camera.
